(19) United States
(12) Patent Application Publication
(10) Pub. No.: US 2005/0041845 A1
(43) Pub. Date: Feb. 24, 2005

(54) Medical imaging system with tissue-selective image sharpening

(76) Inventor: Randall Kenneth Payne, Madison, WI (US)

Correspondence Address: QUARLES & BRADY LLP, 411 E. WISCONSIN AVENUE, SUITE 2040, MILWAUKEE, WI, 53202-4497, US

(21) Appl. No.: 10/644,236

(22) Filed: Aug. 20, 2003

(51) Int. Cl. G06K 9/00; G06K 9/40

(52) U.S. Cl. 382/132; 382/263

(57) ABSTRACT

Medical images from x-rays or the like are enhanced by characterizing pixels of the image as to the type of underlying tissue and selectively applying image enhancement techniques only to particular tissue types.

### CROSS-REFERENCE TO RELATED APPLICATIONS

### STATEMENT REGARDING FEDERALLY SPONSORED RESEARCH OR DEVELOPMENT

### BACKGROUND OF THE INVENTION

The present invention relates to medical imaging systems and in particular to an imaging system that sharpens portions of an image based on a determination of the underlying tissue type.

Diagnostic images of the lateral spine, for example, using dual energy x-ray, may be used to assess the presence of spinal fractures incident to osteoporosis and other bone diseases. A vertebra with upper and lower surfaces that are wedge shaped, concave, or compressed together may have experienced a fracture.

Often the edges of the vertebra are indistinct in the image. Sharpening filters, operating on the data underlying the image, may be used to highlight the edges of the vertebrae but will also highlight features in soft tissue around the bone such as the diaphragm, organs, ribs, abdominal gas, and other distracting tissue structures.

### SUMMARY OF THE INVENTION

The present invention provides a method of sharpening only selected tissue types in a medical diagnostic image. In this way, for example, the bone image may be sharpened without generating distracting artifacts in the surrounding soft tissue. Alternatively, features in soft tissue may be sharpened without accentuating surrounding bone.

The invention is particularly suited to dual energy x-ray images which may automatically characterize image data based on tissue types, but the invention may also be applied to other imaging modalities where tissue type may be approximately identified. The user may manually adjust the regions automatically identified.

### BRIEF DESCRIPTION OF THE FIGURES

FIG. 1 is a simplified perspective view of a bone densitometer such as may collect dual energy x-ray attenuation measurements over a region of a patient supported on a patient table;

FIG. 2 is an example lateral bone scan taken by the densitometer of FIG. 1 showing the vertebral column surrounded by soft tissue and further showing a paintbrush cursor and a virtual slider control;

FIG. 3 is a histogram sorting the data underlying the image of FIG. 2 showing a bi-modality such as may be used to identify tissue types; and

FIG. 4 is a block diagram showing the steps of a computer program implementing the present invention in the densitometer of FIG. 1.

### DETAILED DESCRIPTION OF THE PREFERRED EMBODIMENT

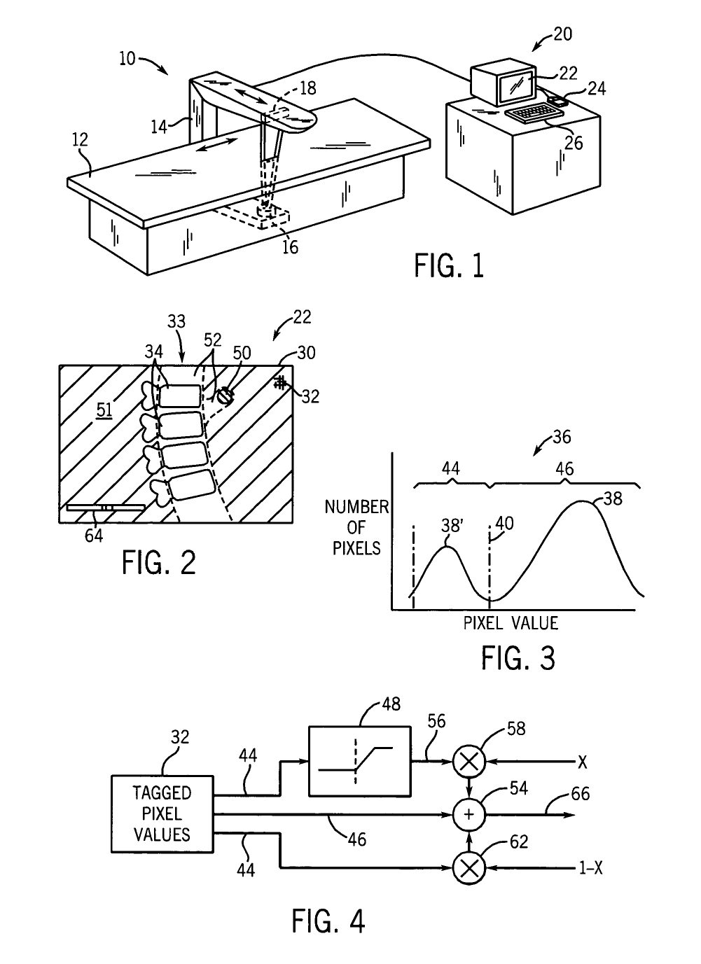

Referring now to FIG. 1, a dual energy x-ray densitometer 10 may include a patient table 12 for supporting a patient (not shown) near a C-arm 14 having two horizontally extending arms, one positioned above and one positioned below the surface of the patient table 12. The lower arm of the C-arm 14 supports an x-ray source 16 providing for two energies of x-rays in an upwardly directed beam passing through the patient table 12 and patient to be received by an x-ray detector 18 mounted on the upper arm of the C-arm 14. Both the x-ray detector 18 and x-ray source 16 are mounted for scanning across the patient to obtain attenuation information through the patient at two energy levels.

Control of the scanning motion and operation of the x-ray detector 18 and x-ray source 16 of the x-ray densitometer 10 is provided by a computer system 20 executing a stored control program stored in computer memory. The computer system 20 includes generally a screen 22, a cursor control device 24 (such as a mouse), and a keyboard 26 as are well understood in the art. An x-ray densitometer 10 as described above, and suitable for use with the present invention, is commercially available from General Electric Company of the United States under the trade name Prodigy.

Referring now also to FIG. 2, the x-ray densitometer of FIG. 1 may be used to produce an image 30 such as may be displayed on the screen 22. As shown, an example image 30 may be that of laterally viewed lumbar vertebrae 34 such as form a portion of the spinal column taken with the patient lying on his or her side on the patient table 12. Per conventional practice, this image 30 is developed by conducting a scan of the x-ray detector 18 and x-ray source 16 to collect attenuation measurements along a number of vertical rays through a volume of the patient. The attenuation measurements along with the location of the rays is stored in the memory of the computer system 20 where this data is mapped to pixels 32 together forming the image 30. The location of each pixel 32 within the image 30 corresponds to the location of the underlying ray and the brightness of each pixel 32 is a function of the attenuation measurements at that location. When two attenuation measurements are associated with each pixel 32, as is the case in an x-ray densitometer 10, the brightness of the pixels 32 may be determined from a simple average of the attenuation values or other mathematical combination, or from either the high energy attenuation or the low energy attenuation value.

Referring to FIG. 3, the attenuation measurements underlying each of the pixels 32 may be sorted by a program executed on computer system 20 to develop a histogram 36 indicating the number of pixels 32 at each “pixel value”. For the case of the dual energy x-ray densitometer 10 of FIG. 1, two attenuation measurements (one for high energy and one for low energy) are associated with each pixel 32 and the pixel value forming the horizontal axis of the histogram 36 may be, for example, a ratio of attenuation attributable to bone to attenuation attributable to soft tissue.

The histogram 36 in this case will show multiple modes 38 and 38′ corresponding to different tissue types (e.g. bone and soft tissue). A threshold value 40 may be established separating the modes 38′ and 38, for example, by finding a local minima within an empirically established range and used to sort each pixel 32 of FIG. 2 into one of two tissue types of bone and soft tissue depending on whether it is above or below the threshold value 40. The threshold value 40 may be adjustable by the user and the empirically established range may be determined for each particular x-ray densitometer 10 based on its calibration and studies of patients.

According to the sorting with the threshold value 40, each pixel 32 of the image 30 is tagged in the memory of the computer system 20 with its tissue type to generate a bone pixel set 44 having attenuation caused principally by bone and a soft tissue pixel set 46 having attenuation caused principally by soft tissue. These sets may be optionally filtered using a spatial filtering system based on pixel location to provide that each of the bone pixel set 44 and soft tissue pixel set 46 define locally continuous regions uninterrupted by single pixels of the other tissue type. (?)

Generally, an x-ray densitometer 10 may only distinguish between two types of tissues, however more complex algorithms, for example, those which look at spatial locations of the pixels 32 in addition to attenuation values, may approximate divisions into greater numbers of tissue types as may be used by the present invention or may be used to refine the two tissue characterizations described. The present invention may also find use with other tissue identification techniques and may be used with single energy x-ray systems in which tissue types are deduced from single energy attenuation, for example, in a CT machine or standard x-ray system. While the tissue types of bone and soft tissue are used in this example, clearly other tissue types such as fat and non-fat tissue may be used.

Referring again to FIGS. 2 and 3, the pixels of one of the pixel sets 44 and 46 (in this case soft tissue pixel set 46) may be tinted to produce a semi-transparent colored masked area 51 (depicted in FIG. 2 by cross-hatching) overlaid on otherwise gray-scale pixels 32 to distinguish one pixel set from the other in the image 30. The particular tissue associated with the masked area 51 may be selected by the user and the masked area 51 may be altered by the user to change the characterization of the underlying pixels 32 irrespective of their pixel values. Specifically, using a menu command, the user may invoke a paintbrush tool 50 movable over the screen 22 by use of the cursor control device 24. The paintbrush tool 50 may be used to “paint” on additional masked area 51 or to erase masked area 51 to produce additional unmasked area 52 per standard computer graphics techniques. In this way, the user may correct or alter the selection of or sorting of the pixels 32 into the two tissue types particularly if the automatic tissue identification does not pick the area of interest.

In a preferred embodiment, this masked area 51 may be low-pass filtered to create a “soft mask” eliminating abrupt visual transitions in the final filtered image. For example, in a mask that provides a binary state of 1 for areas included by the mask and 0 for areas excluded by the mask, where the mask is applied by a simple multiplication of pixels of the underlying image times corresponding mask pixels, the mask is filtered to create a transition region at the interface between mask regions of 0 and 1, the transition region having fractional values, the lower the fractional value the less the contribution of the underlying image in the final masked image.

Referring now to FIG. 4, the bone pixel set 44 may be provided to a high-pass filter 48 which accentuates spatially high frequency components of the image 30, for example, image edges to produce high-pass filtered data 56. The high-pass filter 48 affects only the image formed from the bone pixel set 44 and thus can be considered as being restricted to the unmasked area 52 as possibly modified by the user. In the example of FIG. 2, therefore, the edges of the vertebral column 33 would be emphasized but no emphasis would occur in the soft tissue of masked area 51. To the extent that the invention is used to thus sharpen the bone soft tissue interface, it can aid in analyzing bone morphology.

The high-pass filter 48 may be implemented in a number of ways well known to those of ordinary skill in the art including, for example, by taking a derivative of the unmasked area 52 of the image 30 or use of the Fourier transform, a truncation of low frequency data and a reverse Fourier transform of operating on the unmasked area 52 of the image 30. In a simple embodiment, a low-pass filtered image may be obtained using averaging techniques or the like and subtracted from the unmasked area 52 of the image 30 leaving high-pass filtered data 56.

The high-pass filtered data 56 is provided to a multiplier 58 which receives a weighting value x as will be described below. The product of the high-pass filtered data 56 and the weighting value x is provided to an adder 54.

The soft tissue pixel set 46 is provided directly to the adder 54.

The bone pixel set 44, prior to high-pass filtering, is also provided to multiplier 62 which receives a weighting value 1−x. The product of the high-pass filtered data 56 and the weighting value 1−x is provided to an adder 54.

The adder 54 provides an output 66 which provides new brightness values for pixels 32 to be displayed as an enhanced image on the screen 22 providing improved bone edge enhancement without enhancing features of the soft tissue.

Referring now also to FIG. 2, the amount of edge enhancement in the unmasked area 52 will be a function of the weighting variable x. In the preferred embodiment, this value of weighting variable x is determined by the user through a virtual slider 64 that may be displayed on the screen 22 and manipulated by the cursor control device 24 according to techniques well known in the art. The user in real time may adjust the slider 64 varying x between zero, and 1 where x=0 provides for no edge emphasis and x=1 provides full emphasis to the selected tissue of the unmasked area 52. Note that the image of the masked area 51, for example soft tissue, is unaffected by this process. The invention may in this way allow enhancement of selected tissue types without creating distracting artifacts in adjacent different tissue types. The slider 64 allows the user to simply adjust the enhancement amount without complex controls requiring a detailed knowledge of image processing.

By changing the particular tissue selected in the unmasked area 52, other areas of the image can be accentuated or de-emphasized including regions including air or artifacts such as metal or the like. In addition, other filter strategies can be applied to the masked area 51, for example, the soft tissue may be further processed by low pass filtering to decrease its presence in the image or a high-pass filter to control or accentuate its presence in the image. The high-pass filtering may be applied to fat tissue when fat and non-fat tissue are analyzed.

It is specifically intended that the present invention not be limited to the embodiments and illustrations contained herein, but include modified forms of those embodiments including portions of the embodiments and combinations of elements of different embodiments as come within the scope of the following claims.

1. A method of enhancing images of combined tissue types comprising the steps of:
(a) sorting pixels of an image of a combined tissue type into at least two categories of tissue;
(b) defining at least two zones encompassing regions of a given tissue type
(c) applying an image sharpening filter selectively to only a given one of the two zones; and
(d) producing an output image with the given zone modified by the image sharpening filter.

2. The method of claim 1 wherein the image sharpening filter is a spatial high-pass filter.

3. The method of claim 1 wherein the two categories of tissues are bone and soft tissue.

4. The method of claim 1 wherein the given tissue type is bone.

5. The method of claim 1 wherein the two categories of tissues are fat and non-fat tissue.

6. The method of claim 1 wherein the given tissue type is fat.

7. The method of claim 1 further including accepting from a user a sharpening amount input and where the output image in the given zone is a combination of the given zone modified by the image sharpening filter and the given zone unmodified by the image sharpening filter.

8. The method of claim 1 wherein the sharpening amount input is received from a virtual control displayed on a screen showing the output image and wherein the modification of the given zone is performed substantially in real time.

9. The method of claim 1 further including accepting from user a zone modification input modifying the given zone.

10. The method of claim 1 wherein the zone modification input is received by a cursor control device manipulating a zone mask superimposed on the image displayed on a screen.

11. The method of claim 1 including the step of deriving the image from a dual energy x-ray and wherein the sorting pixels determines the tissue type by a comparison of attenuation at the two energies of x-ray.

12. An apparatus for imaging multiple tissue types comprising:
an x-ray source and detector for collecting x-ray attenuation data over a region of a patient to define pixels of an image;
a computer receiving the attenuation data and execution of a stored program to:
(a) sort pixels of the image into at least two categories of tissue;
(b) define at least two zones encompassing regions of a given tissue type;
(c) apply an image sharpening filter selectively to a given one but less than all of the zones; and
(d) produce an output image with the given zone modified by the image sharpening filter.

13. The apparatus of claim 12 wherein the image sharpening filter is a spatial high-pass filter.

14. The apparatus of claim 12 wherein the spatial high-pass filter is implemented by subtracting a spatial low pass filtered image from the image.

15. The apparatus of claim 12 wherein the two categories of tissues are bone and soft tissue.

16. The apparatus of claim 12 wherein the given tissue type is bone.

17. The apparatus of claim 12 wherein the two categories of tissues are fat and non-fat tissue.

18. The apparatus of claim 12 wherein the given tissue type is fat.

19. The apparatus of claim 12 further including a user input device accepting from a user a sharpening amount input and wherein the computer program further executes to produce the output image in the given zone as a combination of the given zone modified by the image sharpening filter and the given zone unmodified by the image sharpening filter.

20. The apparatus of claim 12 wherein the computer program further executes to implement a virtual control on the screen and wherein the sharpening amount input is received from a virtual control and wherein the modification of the given zone is performed substantially in real time.

21. The apparatus of claim 12 further including an input device accepting from a user, a zone modification input modifying the given zone.

22. The apparatus of claim 12 wherein the computer program further executes to implement a painting cursor and wherein the zone modification input is received from the painting cursor manipulating a zone mask superimposed on the image displayed on a screen.

23. The apparatus of claim 12 wherein the x-ray source and x-ray detector produce attenuation data at two energies of x-ray.
